(19) United States
(12) Patent Application Publication
(10) Pub. No.: US 2014/0159849 A1
(43) Pub. Date: Jun. 12, 2014

(54) ELECTRONIC COMPONENT AND METHOD OF MANUFACTURING THE SAME

(71) Applicant: Samsung Electro-Mechanics Co., Ltd., Suwon-si (KR)

(72) Inventors: Jun Hee BAE, Suwon-si (KR); Sang Moon Lee, Suwon-si (KR); Sung Kwon Wi, Suwon-si (KR); Yong Suk Kim, Suwon-si (KR)

(73) Assignee: Samsung Electro-Mechanics Co., Ltd., Suwon-si (KR)

(21) Appl. No.: 14/101,496

(22) Filed: Dec. 10, 2013

(30) Foreign Application Priority Data
Dec. 11, 2012 (KR) 10-2012-0143614

(51) Int. Cl. H01F 27/29; H01F 41/10

(52) U.S. Cl. CPC H01F 27/29; H01F 41/10
USPC 336/192; 29/605

(57) ABSTRACT

Disclosed herein are an electronic component and a method of manufacturing the same. In the electronic component having a hexahedral shape and including an insulating portion formed on an upper part of a base substrate, a coil pattern portion formed in the insulating portion and wound with a conductive wire, and a plurality of external electrodes separated from each other and electrically connected with the coil pattern portion, each external electrode covers a part of an upper surface of the insulating portion and extending to an upper surface of the electronic component and a region between the external electrodes is provided with a ferrite block covering an exposed surface of the insulating portion, thereby improving magnetic permeability as compared with the electronic component of the related art.

### CROSS REFERENCE(S) TO RELATED APPLICATIONS

This application claims the benefit under 35 U.S.C. Section 119 of Korean Patent Application Serial No. 10-2012-0143614 entitled “Electronic Component And Method Of Manufacturing The Same” filed on Dec. 11, 2012, which is hereby incorporated by reference in its entirety into this application.

### BACKGROUND OF THE INVENTION

1. Technical Field

The present invention relates to an electronic component and a method of manufacturing the same.

2. Description of the Related Art

Recently, a large amount of data can be transmitted/received within a short time of period thanks to the widespread distribution of electronic devices for transmitting/receiving data using a wireless communication method and the development of communication technologies, data processing technologies and circuit integrated technologies, and the like.

Meanwhile, electronic devices using the wireless communication method need to accurately extract data by effectively removing noise included in a signal and have specific components that remove noise so as to accurately collect only the specific signal among the overflowing radio signals.

Further, radio signals including data and power supply voltage or power supply current supplied to various integrated circuit equipped in electronic devices include noises, such that there is a need for components to remove the noises.

In this case, an example of representative components generally used to remove noises may include a common mode filter, a differential mode filter, and the like.

The noise removal characteristics of the electronic components may be determined by various factors. However, among those, magnetic permeability may be regarded as an important index that determines the noise removal characteristics of electronic components.

Meanwhile, Patent Document 1 discloses a common mode filter that is configured of a laminate of a coil pattern, an insulating layer, a magnetic substance, and the like and connected with a coil pattern while surrounding the laminate with a plate-shaped external electrode.

In this case, a portion providing the magnetic permeability in the common mode filter is a magnetic substance, in which the general magnetic substance of the related art is configured of a mixture of a magnetic material and a synthetic resin, such that there is a limitation in improving magnetic permeability.

Further, a laminated common mode filter having a type disclosed in Patent Document 1 is difficult to implement miniaturization of the coil pattern and slimness of the common mode filter due to heat and pressure applied during the lamination process.

Further, as the laminate is completed and the external electrode is individually formed, there are problems in that the process efficiency may be reduced and the electrical connectivity between the coil pattern and the external electrode may be poor.

### RELATED ART DOCUMENT

### Patent Document

(Patent Document 1) US Patent Laid-Open Publication No. US2012-0119863

### SUMMARY OF THE INVENTION

An object of the present invention is to provide an electronic component with improved noise characteristics according to improved magnetic permeability and with improved manufacturing efficiency while being miniaturized and slimmed, and a method of manufacturing an electronic component.

According to an exemplary embodiment of the present invention, there is provided an electronic component having a hexahedral shape and including an insulating portion formed on an upper part of a base substrate, a coil pattern portion formed in the insulating portion and wound with a conductive wire, and a plurality of external electrodes separated from each other and electrically connected with the coil pattern portion, wherein each external electrode covers a part of an upper surface of the insulating portion and extending to an upper surface of the electronic component and a region between the external electrodes is provided with a ferrite block covering an exposed surface of the insulating portion.

The ferrite block may be formed by curing slurry formed of a mixture of a material including ferrite powders and a binder with a solvent.

A grain size of the ferrite powder may be 0.5 to 1 μm.

In the slurry, a composition ratio of the ferrite powders, the binder, and the solvent may be 10 to 15:0.1 to 1:1 to 5.

The electronic component may further include: an adhesive resin provided between the external electrodes and between the ferrite block and the external electrodes.

According to another exemplary embodiment of the present invention, there is provided an electronic component having a hexagonal shape, including: a base substrate formed of an insulating material; a first insulating portion covering an upper surface of the base substrate; a coil pattern portion formed on an upper surface of the first insulating portion and including a primary coil pattern formed by winding a conductive wire therearound at least once and a secondary coil pattern electrically separated from the primary coil pattern; a second insulating portion covering the coil pattern portion; a first primary external electrode electrically connected with one end of the primary coil pattern; a second primary external electrode electrically connected with the other end of the primary coil pattern; a first secondary external electrode electrically connected with one end of the secondary coil pattern; and a second secondary external electrode electrically connected with the other end of the secondary coil pattern, wherein the first primary external electrode, the second primary external electrode, the first secondary external electrode, and the second secondary external electrode cover a part of the upper surface of the second insulating portion and a region between the first primary external electrode and the second primary external electrode and a region between the first secondary external electrode and the second secondary external electrode are provided with ferrite blocks that cover an exposed upper surface of the second insulating portion.

Upper surfaces of the first primary external electrode, the second primary external electrode, the first secondary external electrode, and the second secondary external electrode and an upper surface of the ferrite block may form an upper surface of the electronic component.

The ferrite block may be formed of ferrite powders, a binder, and a solvent.

A weight ratio of the ferrite powders in the ferrite block may be 90 wt % or more.

The electronic component may further include: an adhesive resin provided between the ferrite block and the first primary external electrode, the second primary external electrode, the first secondary external electrode, and the second secondary external electrode.

According to a still another exemplary embodiment of the present invention, there is provided a method of manufacturing an electronic component having a hexahedral shape and including an insulating portion formed on an upper part of a base substrate, a coil pattern portion formed in the insulating portion and wound with a conductive wire, and a plurality of external electrodes separated from each other and electrically connected with the coil pattern portion, the method including: coupling a ferrite block with a region between the external electrodes, wherein each external electrode covers a part of an upper surface of the insulating portion and extending to an upper surface of the electronic component.

The ferrite block may be manufactured by performing a process including: forming a ferrite sheet by curing slurry formed of a mixture of a material including ferrite powders and a binder with a solvent; attaching a carrier film to a bottom surface of the ferrite sheet; dicing the ferrite sheet in a predefined shape; and removing a region other than the ferrite block in the diced ferrite sheet.

The ferrite powder may have a grain size of 0.5 to 1 μm and the slurry may be mixed so that a composition ratio of the ferrite powders, the binder, and the solvent is 10 to 15:0.1 to 1:1 to 5.

The carrier film may have reduced adhesion characteristics when being irradiated with ultraviolet rays and the removing of the region other than the ferrite block in the diced ferrite sheet may include forming a mask covering a surface of a region corresponding to the ferrite block in a lower surface of the carrier film and irradiating ultraviolet rays.

The coupling of the ferrite block with the region between the external electrodes may include positioning the ferrite block in the region between the external electrodes and applying an adhesive resin on the external electrode and the ferrite block to penetrate the adhesive resin between the ferrite block and the external electrodes.

The adhesive resin may include epoxy resin having a viscosity of 1 to 10 cPs.

### BRIEF DESCRIPTION OF THE DRAWINGS

FIG. 1 is a perspective view schematically illustrating an electronic component according to an exemplary embodiment of the present invention.

FIG. 2 is a cross-sectional view schematically illustrating a surface taken along the line I-I′ of FIG. 1.

FIG. 3 is a cross-sectional view of an electronic component according to another exemplary embodiment of the present invention.

FIGS. 4A to 4H are process cross-sectional views schematically illustrating a method of manufacturing an electronic component according to another exemplary embodiment of the present invention, in which FIG. 4A illustrates a state in which a ferrite sheet is formed, FIG. 4B illustrates a state in which a carrier film is attached to the ferrite sheet, FIG. 4C illustrates a state in which a ferrite block is formed on the carrier film, FIG. 4D illustrates a state in which the ferrite block is disposed between external electrodes, FIG. 4E illustrates a state in which the ferrite block overturns so as to be disposed on an upper part thereof and the carrier film is removed, FIG. 4F illustrates a state in which an adhesive resin is applied, FIG. 4G illustrates a state in which the adhesive resin penetrates between the external electrodes and the ferrite block, and FIG. 4H is a cross-sectional view schematically illustrating a state in which dicing is performed along a dicing line to manufacture the electronic component.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art. Like reference numerals throughout the description denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

For simplification and clearness of illustration, a general configuration scheme will be shown in the accompanying drawings, and a detailed description of the feature and the technology well known in the art will be omitted in order to prevent a discussion of exemplary embodiments of the present invention from being unnecessarily obscure. Additionally, components shown in the accompanying drawings are not necessarily shown to scale. For example, size of some components shown in the accompanying drawings may be exaggerated as compared with other components in order to assist in understanding of exemplary embodiments of the present invention. Like reference numerals on different drawings will denote like components, and similar reference numerals on different drawings will denote similar components, but are not necessarily limited thereto.

In the specification and the claims, terms such as “first”, “second”, “third”, “fourth” and the like, if any, will be used to distinguish similar components from each other and be used to describe a specific sequence or a generation sequence, but is not necessarily limited thereto. It may be understood that these terms are compatible with each other under an appropriate environment so that exemplary embodiments of the present invention to be described below may be operated in a sequence different from a sequence shown or described herein. Likewise, in the present specification, in the case in which it is described that a method includes a series of steps, a sequence of these steps suggested herein it not necessarily a sequence in which these steps may be executed. That is, any described step may be omitted and/or any other step that is not described herein may be added to the method.

In the specification and the claims, terms such as “left”, “right”, “front”, “rear”, “top, “bottom”, “over”, “under”, and the like, if any, are not necessarily to indicate relative positions that are not changed, but are used for description. It may be understood that these terms are compatible with each other under an appropriate environment so that exemplary embodiments of the present invention to be described below may be operated in a sequence different from a sequence shown or described herein. A term “connected” used herein is defined as being directly or indirectly connected in an electrical or non-electrical scheme. Targets described as being “adjacent to” each other may physically contact each other, be close to each other, or be in the same general range or region, in the context in which the above phrase is used. Here, a phrase “in an exemplary embodiment” means the same exemplary embodiment, but is not necessarily limited thereto.

Hereinafter, a configuration and an acting effect of exemplary embodiments of the present invention will be described in more detail with reference to the accompanying drawings.

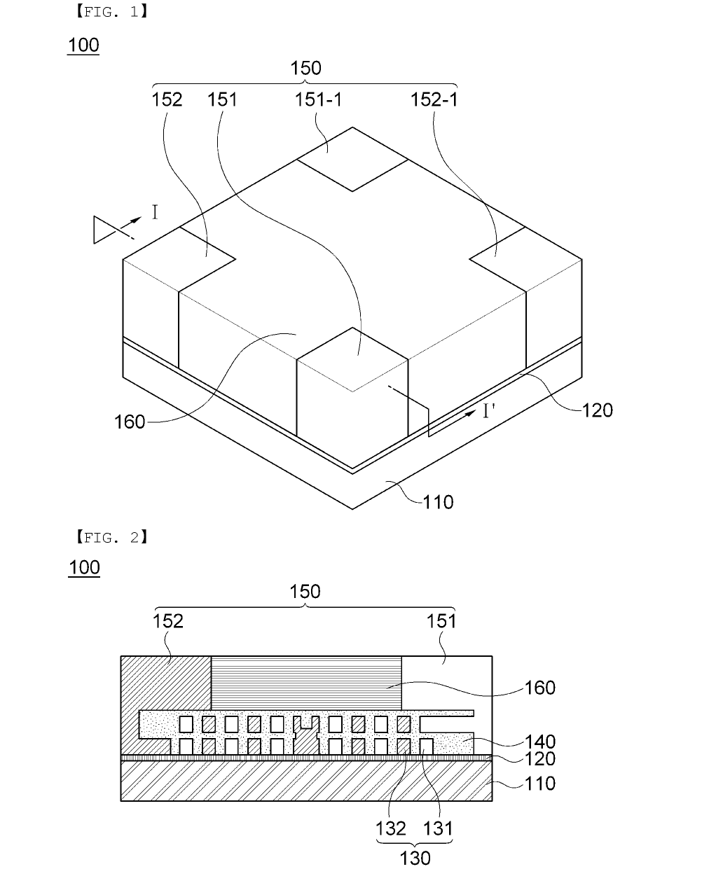

FIG. 1 is a perspective view schematically illustrating an electronic component 100 according to an exemplary embodiment of the present invention.

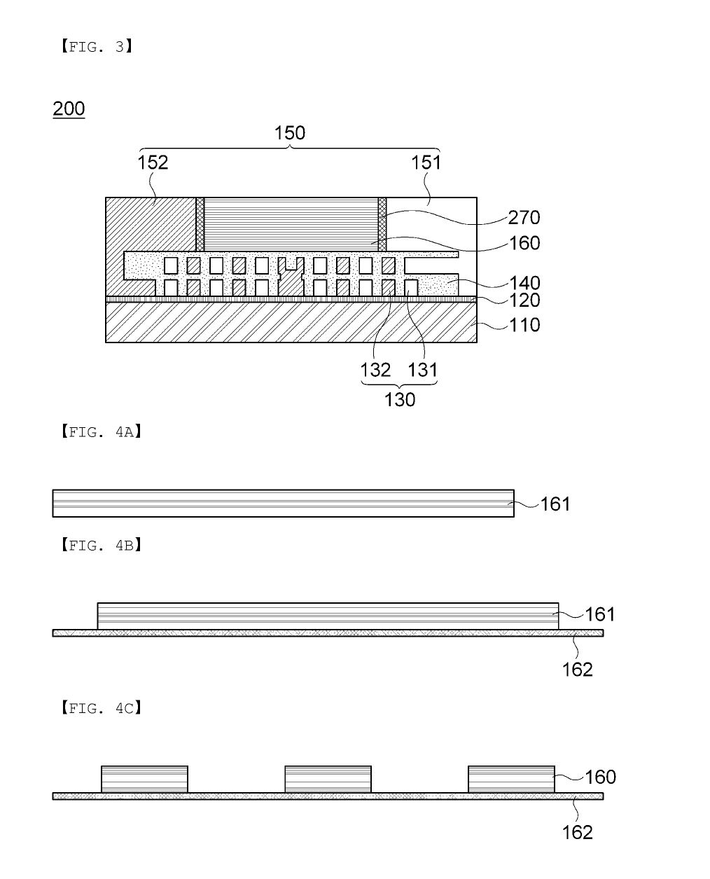

FIG. 2 is a cross-sectional view schematically illustrating a surface taken along the line I-I′ of FIG. 1.

Referring to FIGS. 1 and 2, the electronic component 100 according to the exemplary embodiment of the present invention may largely include a base substrate 110, insulating portions 120 and 140, a coil pattern portion 130, a plurality of external electrodes, and a ferrite block 160.

The base substrate 110 may include a magnetic material and a surface of the base substrate 110 may be provided with a first insulating portion 120 so as to secure insulation between the magnetic material and a coil pattern.

A surface of the first insulating portion 120 may be provided with the coil pattern and the coil pattern may be formed by winding a conductive wire formed of a conductive material therearound at least once.

In this case, the coil pattern may be at least one strand. That is, the coil pattern may be configured of a primary coil pattern 131 and a second coil pattern 132.

Further, as illustrated, the coil pattern may be formed in two layers or more, if necessary.

Meanwhile, the second insulating portion 140 may be provided to enclose the coil pattern portion 130 so as to prevent the coil patterns, the primary coil pattern 131 and the secondary coil pattern 132, and adjacent ones of the coil patterns formed on different layers from electrically contacting each other.

Next, a plurality of external electrodes, for example, a first primary external electrode 151, a second primary external electrode 151-1, a first secondary external electrode 152, and a second secondary external electrode 152-1 may each cover a part of the surface of the second insulating portion 140 while being electrically connected with one end and the other end of the coil patterns, respectively. Further, the external electrodes may extend from the surface of the second insulating portion 140 to the upper surface of the electronic component 100.

Meanwhile, the coil patterns and the external electrodes may be formed by a photoresist technique.

That is, a photoresist layer (not illustrated) is formed on the surface of the first insulating portion 120 and a region in which the coil patterns and the external electrodes are formed on the photoresist layer is patterned and then subjected to processes such as plating, thereby forming the coil patterns and the external electrodes.

If necessary, a similar method may be performed even when the coil pattern is formed in a plurality of layers.

Further, the same method may be performed even in the process of forming an external electrode portion 150 on the surface of the second insulating portion 140.

Next, a ferrite block 160 is provided in a region between the external electrodes and a lower surface of the ferrite block 160 may contact the surface of the second insulating portion 140.

In this case, the ferrite block 160 may be formed by curing slurry that is prepared by mixing ferrite powders and a binder with a solvent.

In particular, the slurry may include the ferrite powders having a grain size of 0.5 to 1 μm of 2 to 15 times with respect to a solvent mass and the binder of 0.02 to 1 times with respect to a solvent mass.

That is, in the slurry, a composition ratio of the ferrite powders, the binder, and the solvent may be 10 to 15:0.1 to 1:1 to 5.

However, in the state in which the ferrite block 160 is manufactured using the slurry, the ratio of the solvent may be lower than in the slurry state. That is, in connection with the ferrite block 160, a weight ratio of the ferrite powders may be 90 wt % or more, such that the magnetic permeability of the electronic component 100 may be more improved.

As described above, one of the main objects of the present invention is to improve the magnetic permeability of the electronic component 100 and when the content of the ferrite powder is lower than the foregoing range, the magnetic permeability is not higher than the related art, which is not preferable.

On the other hand, when the content of the ferrite power is too high, the amount of binder or solvent is relatively insufficient and thus the ferrite powders are firmly coupled, such that the ferrite block 160 may not be formed or the manufacturing field may be reduced during the process of manufacturing the ferrite block 160.

Here, the coil pattern portion 130 is the term including at least one coil pattern, for example, the primary coil pattern 131 and the secondary coil pattern 132, the insulating portion is the term including the first insulating portion 120 and the second insulating portion 140, and the external electrode portion 150 is the term including the first primary external electrode 151, the second primary external electrode 151-1, the first secondary external electrode 152, and the second secondary external electrode 152-1.

According to the foregoing configuration, the electronic component 100 according to the exemplary embodiment of the present invention may more improve the magnetic permeability and the electrical connectivity between the external electrode and the coil pattern, as compared with the electronic component 100 of the related art having the same size.

Further, as described above, the electronic component 100 according to the exemplary embodiment of the present invention has a structure that may be manufactured by using the photoresist technique, such that the coil pattern may be more finely formed and slimmer and slimmer.

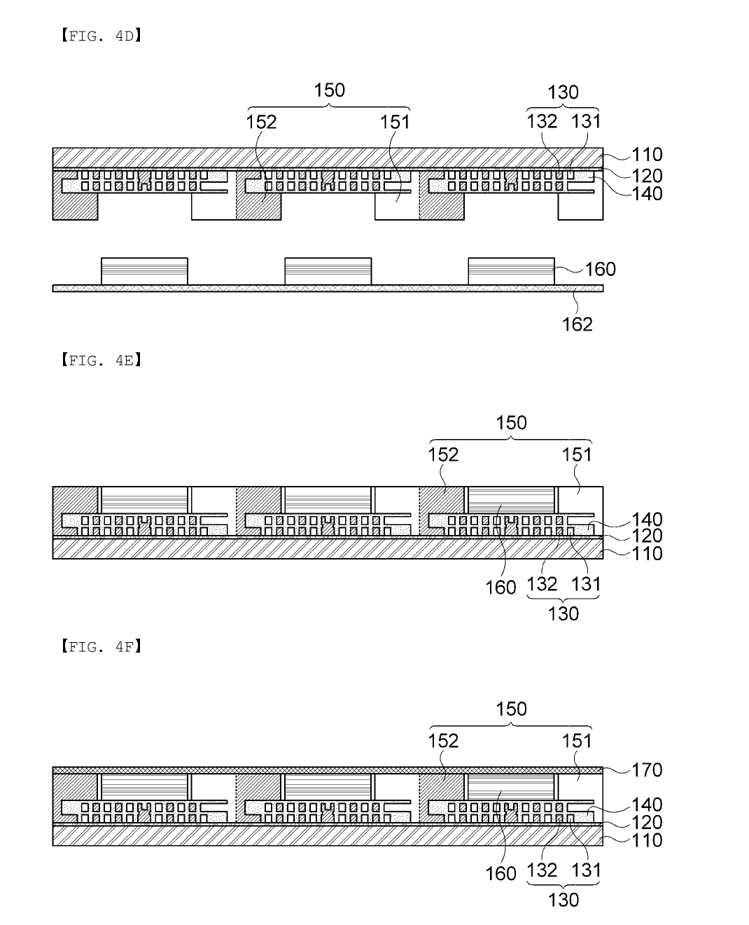

FIG. 3 is a cross-sectional view of an electronic component 200 according to another exemplary embodiment of the present invention.

Referring to FIG. 3, in the electronic component 200 according to the exemplary embodiment of the present invention, an adhesive resin 270 is further provided in a space between the ferrite block 160 and the external electrodes, thereby improving the adhesion of the ferrite block 160.

In this case, the adhesive resin 270 may be a synthetic resin, in particular, epoxy resin having a viscosity of 1 to 10 cPs, such that even when an interval between the ferrite block 160 and the external electrode is 200 μm or less, the epoxy resin may penetrate between the ferrite block 160 and the external electrode using a capillary phenomenon.

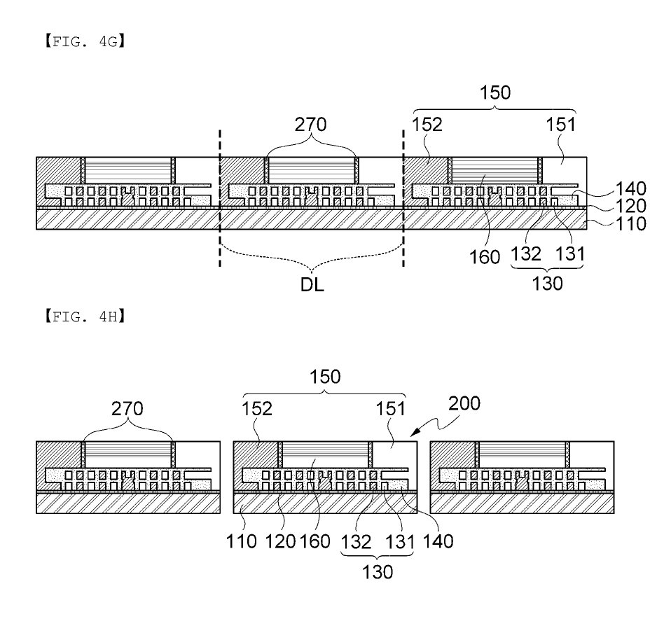

FIGS. 4A to 4F are process cross-sectional views schematically illustrating a method of manufacturing an electronic component according to another exemplary embodiment of the present invention.

First, referring to FIG. 4A, a ferrite sheet 161 is formed using slurry.

In this case, the slurry may include the ferrite powders having a grain size of 0.5 to 1 μm of 2 to 15 times with respect to a solvent mass and the binder of 0.02 to 1 times with respect to a solvent mass.

That is, in the slurry, a composition ratio of the ferrite powders, the binder, and the solvent may be 10 to 15:0.1 to 1:1 to 5.

As described above, the prepared slurry is applied on a predetermined plate at a predetermined thickness and is cured, thereby forming the ferrite sheet 161.

Next, referring to FIG. 4B, the carrier film 162 is attached on the lower surface of the ferrite sheet 161.

Next, referring to FIG. 4C, the ferrite sheet 161 fixed to the carrier film 162 is diced in a necessary shape.

In this case, the diced shape may be determined to correspond to the shape of the region between the external electrodes with which the ferrite block 160 is coupled.

Next, the ferrite sheet of the remaining region except for the region which is the ferrite block 160 is removed. In this case, when the UV film is used as the carrier film 162, a method of covering a mask (not illustrated) covering a surface of the region which is the ferrite block 160, reducing adhesion by irradiating ultraviolet rays to the carrier film 162, and removing the ferrite sheet attached to the carrier film 162 with the reduced adhesion may be applied.

Next, referring to FIG. 4D, one including the base substrate 110, the first insulating portion 120, the coil pattern portion 130, the second insulating portion 140, and the external electrode portion 150 falls down from above the ferrite block 160, such that the ferrite block 160 may be coupled between the external electrodes.

Next, referring to FIG. 4E, a coupled body overturns and then the carrier film 162 is removed so that the ferrite block 160 is disposed on the upper part thereof.

In this case, when the carrier film 162 is a UV film, the adhesion between the carrier film 162 and the ferrite block 160 is reduced by irradiating ultraviolet rays to the overall carrier film 162, thereby easily removing the carrier film 162.

Next, referring to FIGS. 4F and 4G, it can be understood that an adhesive resin 170 may be applied on the upper surface of one illustrated in FIG. 4E and may penetrate between the external electrodes and the ferrite block 160 over time.

In this case, the adhesive resins 170 and 270 may be a synthetic resin, in particular, epoxy resin having a viscosity of 1 to 10 cPs, such that even when an interval between the ferrite block 160 and the external electrode is 200 μm or less, the epoxy resin may penetrate between the ferrite block 160 and the external electrode using a capillary phenomenon.

Further, the adhesive resin 170 remaining on the upper surfaces of the ferrite block 160 and the external electrode portion 150 may be removed by processes, such as grinding, and the like.

Next, referring to FIG. 4H, it can be understood that the dicing process is performed along a dicing line DL illustrated in FIG. 4G and thus, the electronic component 200 may be manufactured.

As the electronic component 200 is manufactured by the foregoing method, the electronic component 200 with the miniaturized coil pattern, the improved electrical connectivity between the coil pattern and the external electrode, and the improved noise removal performance according to the improvement of magnetic permeability can be manufactured.

Further, the electronic component 200 can be mass produced using a large amount of ferrite block 160 attached to the carrier film 162, such that the process efficiency can be more remarkably improved.

As set forth above, according to the exemplary embodiments of the present invention, it is possible to more improve the magnetic permeability than the electronic components of the related art, based on the case in which the electronic components are implemented at the same size.

Further, it is possible to improve the electrical connectivity between the external electrode and the coil pattern, more finely form the coil pattern, and slim the electronic components.

Although the electronic component and the method of manufacturing the same according to the exemplary embodiments of the present invention are described above, the present invention is not limited thereto and therefore, applications and modifications thereof can be made by those skilled in the art.

What is claimed is:

1. An electronic component having a hexahedral shape and including an insulating portion formed on an upper part of a base substrate, a coil pattern portion formed in the insulating portion and wound with a conductive wire, and a plurality of external electrodes separated from each other and electrically connected with the coil pattern portion, wherein each external electrode covers a part of an upper surface of the insulating portion and extending to an upper surface of the electronic component, and
a region between the external electrodes is provided with a ferrite block covering an exposed surface of the insulating portion.

2. The electronic component according to claim 1, wherein the ferrite block is formed by curing slurry formed of a mixture of a material including ferrite powders and a binder with a solvent.

3. The electronic component according to claim 2, wherein a grain size of the ferrite powder is 0.5 to 1 μm.

4. The electronic component according to claim 2, wherein in the slurry, a composition ratio of the ferrite powders, the binder, and the solvent is 10 to 15:0.1 to 1:1 to 5.

5. The electronic component according to claim 1, further comprising:
an adhesive resin provided between the external electrodes and between the ferrite block and the external electrodes.

6. An electronic component having a hexagonal shape, comprising:
a base substrate formed of an insulating material;
a first insulating portion covering an upper surface of the base substrate;
a coil pattern portion formed on an upper surface of the first insulating portion and including a primary coil pattern formed by winding a conductive wire therearound at least once and a secondary coil pattern electrically separated from the primary coil pattern;
a second insulating portion covering the coil pattern portion;
a first primary external electrode electrically connected with one end of the primary coil pattern;
a second primary external electrode electrically connected with the other end of the primary coil pattern;
a first secondary external electrode electrically connected with one end of the secondary coil pattern; and
a second secondary external electrode electrically connected with the other end of the secondary coil pattern;
wherein the first primary external electrode, the second primary external electrode, the first secondary external electrode, and the second secondary external electrode cover a part of the upper surface of the second insulating portion, and
a region between the first primary external electrode and the second primary external electrode and a region between the first secondary external electrode and the second secondary external electrode are provided with ferrite blocks that covers an exposed upper surface of the second insulating portion.

7. The electronic component according to claim 6, wherein upper surfaces of the first primary external electrode, the second primary external electrode, the first secondary external electrode, and the second secondary external electrode and an upper surface of the ferrite block form an upper surface of the electronic component.

8. The electronic component according to claim 7, wherein the ferrite block is formed of ferrite powders, a binder, and a solvent.

9. The electronic component according to claim 8, wherein a grain size of the ferrite powder is 0.5 to 1 μm.

10. The electronic component according to claim 8, wherein a weight ratio of the ferrite powders in the ferrite block is 90 wt % or more.

11. The electronic component according to claim 6, further comprising:
an adhesive resin provided between the ferrite block and the first primary external electrode, the second primary external electrode, the first secondary external electrode, and the second secondary external electrode.

12. A method of manufacturing an electronic component having a hexahedral shape and including an insulating portion formed on an upper part of a base substrate, a coil pattern portion formed in the insulating portion and wound with a conductive wire, and a plurality of external electrodes separated from each other and electrically connected with the coil pattern portion, the method comprising:
coupling a ferrite block with a region between the external electrodes, wherein each external electrode covers a part of an upper surface of the insulating portion and extending to an upper surface of the electronic component.

13. The method according to claim 12, wherein the ferrite block is manufactured by performing a process including:
forming a ferrite sheet by curing slurry formed of a mixture of a material including ferrite powders and a binder with a solvent;
attaching a carrier film to a bottom surface of the ferrite sheet;
dicing the ferrite sheet in a predefined shape; and
removing a region other than the ferrite block in the diced ferrite sheet.

14. The method according to claim 13, wherein the ferrite powder has a grain size of 0.5 to 1 μm, and
the slurry is mixed so that a composition ratio of the ferrite powders, the binder, and the solvent is 10 to 15:0.1 to 1:1 to 5.

15. The method according to claim 13, wherein the carrier film has reduced adhesion characteristics when being irradiated with ultraviolet rays, and
the removing of the region other than the ferrite block in the diced ferrite sheet includes forming a mask covering a surface of a region corresponding to the ferrite block in a lower surface of the carrier film and irradiating ultraviolet rays.

16. The method according to claim 12, wherein the coupling of the ferrite block with the region between the external electrodes includes positioning the ferrite block in the region between the external electrodes and applying an adhesive resin on the external electrodes and the ferrite block to penetrate the adhesive resin between the ferrite block and the external electrodes.

17. The method according to claim 16, wherein the adhesive resin includes epoxy resin having a viscosity of 1 to 10 cPs.
